(19) United States
(12) Patent Application Publication
(10) Pub. No.: US 2026/0116268 A1
(43) Pub. Date: Apr. 30, 2026

(54) VEHICLE SEAT

(71) Applicant: Ford Global Technologies, LLC, Dearborn, MI (US)

(72) Inventors: Srinivas Reddy Malapati, Novi, MI (US); Mangesh Kadam, Canton, MI (US); William Moore Sherwood, Beverly Hills, MI (US); Krishnakanth E. Aekbote, Novi, MI (US)

(73) Assignee: Ford Global Technologies, LLC, Dearborn, MI (US)

(21) Appl. No.: 18/928,245

(22) Filed: Oct. 28, 2024

(51) Int. Cl. B60N 2/02

(52) U.S. Cl. CPC B60N 2/02

(57) ABSTRACT

A vehicle includes a vehicle floor and a vehicle seat mounted to the vehicle floor. The vehicle seat includes a seat bottom rotatable about a rotational axis between a deployed position and a raised position. The seat includes two legs fixed to the seat bottom and spaced from each other along the cross-seat axis. The legs are moveable with the seat bottom between the deployed position and the raised position. The vehicle seat includes a beam fixed directly to the legs and extending along the cross-seat axis from one leg to the other leg. The beam moves with the seat bottom between the deployed position and the raised position. During certain vehicle impacts, the beam counteracts downward force of the pelvis of the occupant to control the kinematics of the occupant, including controlling the kinematics of the occupant relative to a lap belt of a seatbelt.

### BACKGROUND

A vehicle seat is disposed in an occupant cabin of a vehicle to support an occupant during operation of the vehicle. The vehicle seat includes a seat bottom and a seatback. The seat bottom has a pelvis area that supports the pelvis of the occupant.

The vehicle includes a seatbelt assembly for each occupant to control the kinematics of the occupant relative to the seat in response to a vehicle acceleration caused by the vehicle impact. The seatbelt assembly includes a lap belt that extends across the lap of the occupant when buckled. During certain vehicle impacts, the pelvis of the occupant may be forced in a downward direction in compression against the pelvis area of the seat bottom and away from the lap belt of the seatbelt assembly.

### BRIEF DESCRIPTION OF THE DRAWINGS

FIG. 1 is a cut-away view of a vehicle including a seat.

FIG. 2 is a perspective view of the seat on a floor of the vehicle with a seat bottom in a deployed position.

FIG. 3 is a side view of the seat on the floor of the vehicle with the seat bottom in the deployed position.

FIG. 4 is a perspective view of the seat on the floor of the vehicle with a seat bottom in a raised position.

FIG. 5 is a side view of the seat on the floor of the vehicle with the seat bottom in the raised position.

FIG. 6 is a perspective view of another example of the seat with the seat bottom in the raised position.

FIG. 7 is a side view of the example of FIG. 6 with the seat bottom in the raised position.

### DETAILED DESCRIPTION

With reference to the Figures, wherein like numerals indicate like parts throughout the several views, a vehicle 10 includes a vehicle floor 12 and a vehicle seat 14 mounted to the vehicle floor 12. The vehicle seat 14 has a cross-seat axis CS. The vehicle seat 14 includes a seatback 16. The vehicle seat 14 includes a seat bottom 18 rotatably connected to seatback 16 about a rotational axis R. The rotational axis R extends along the cross-seat axis CS. The seat bottom 18 is rotatable relative to the seatback 16 about the rotational axis R between a deployed position and a raised position. The seat 14 includes two legs 22 fixed to the seat bottom. The two legs 22 are spaced from each other along the cross-seat axis CS. The legs 22 are moveable with the seat bottom 18 between the deployed position and the raised position. The legs 22 contact the floor 12 in the deployed position and are spaced from the floor 12 in the raised position. The vehicle seat 14 includes a beam 24 fixed directly to the legs 22 and extending along the cross-seat axis CS from one leg 22 to the other leg 22. The beam 24 moves with the seat bottom 18 between the deployed position and the raised position.

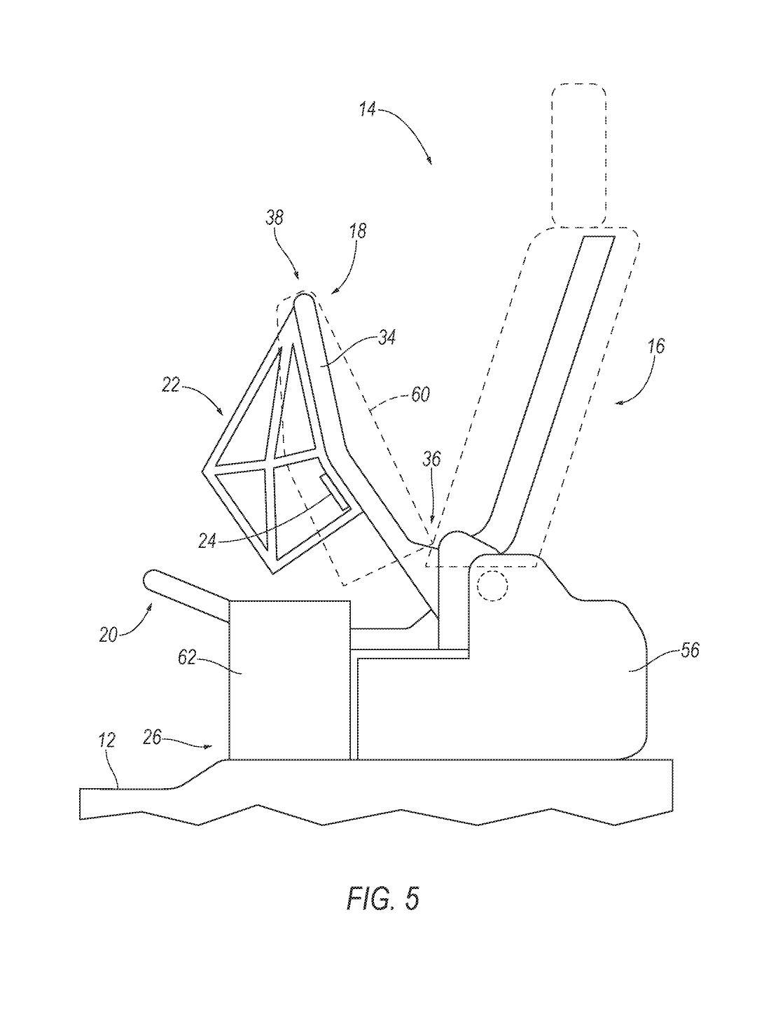

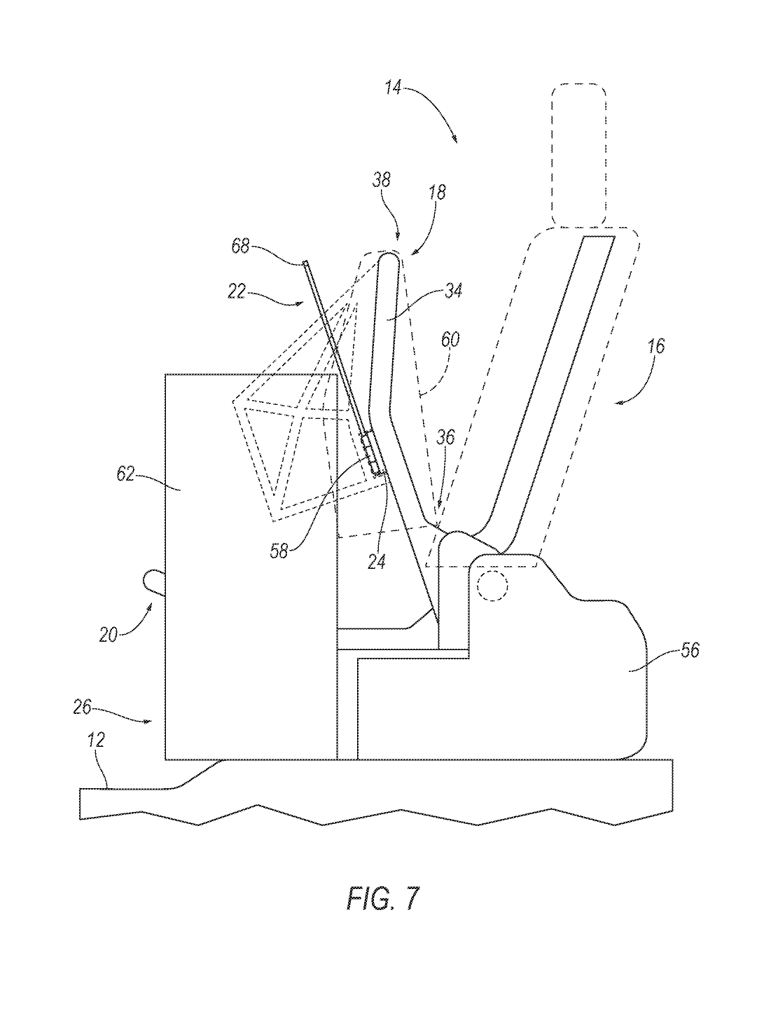

In the deployed position, the seat bottom 18 is positioned to support one or more occupants, and in the raised position, the seat 14 and the floor 12 define a cargo area 26 between the seat 14 and the floor 12. When in the deployed position, the beam 24 is below a pelvis area 28 of the seat bottom 18. When seated on the seat 14, the pelvis of an occupant is seated on the pelvis area 28 of the seat bottom 18. During certain vehicle impacts, the pelvis of the occupant may be forced in a downward direction in compression against the pelvis area 28 of the seat bottom 18. The beam 24, being below the pelvis area 28 of the seat bottom 18, counteracts this downward force to control the kinematics of the occupant, including controlling the kinematics of the occupant relative to a lap belt 50 of a seatbelt assembly 46. Since the beam 24 is fixed directly to the legs 22 and extends along the cross-seat axis CS from one leg 22 to the other leg 22, the beam 24 distributes the downward force to the legs 22, and the seat 14 defines a load path from the beam 24 through the legs 22 to the floor 12. When the seat bottom 18 is in the raised position, the beam 24 is outside the cargo area 26 to allow for ingress and egress of cargo 62 in the cargo area 26. Examples of cargo 62 is shown in FIGS. 5 and 7.

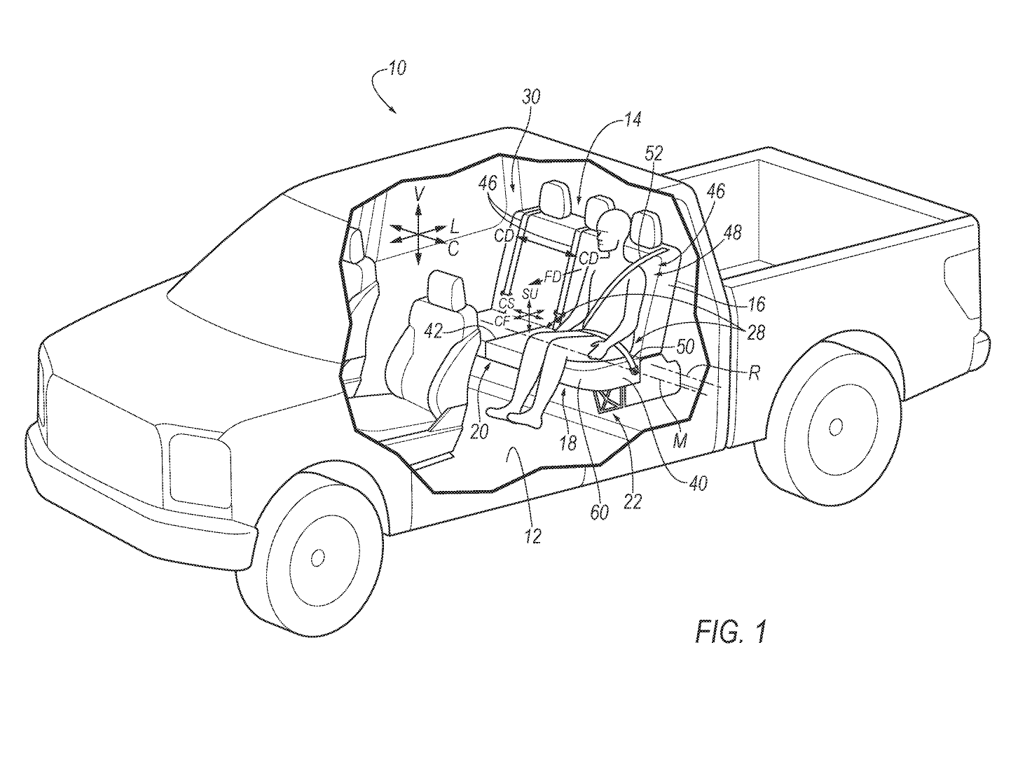

The vehicle 10 may be any suitable type of automobile, e.g., a passenger or commercial automobile such as a sedan, a coupe, a truck, a sport utility, a crossover, a van, a minivan, a taxi, a bus, etc. In the example shown in the Figures, for example, the vehicle 10 is a pickup truck. The vehicle 10 defines an occupant cabin 30. With reference to FIG. 1, the vehicle 10 defines a vehicle-longitudinal axis L extending between a front end (not numbered) and a rear-end (not numbered) of the vehicle 10. The vehicle 10 defines a vehicle-lateral axis A extending cross-vehicle from one side to the other side of the vehicle 10. The vehicle 10 defines a vertical axis V extending through the floor 12 and roof of the vehicle 10. The vehicle-longitudinal axis L, the vehicle-lateral axis A, and the vertical axis V are perpendicular relative to each other.

The vehicle 10 includes a vehicle body. The vehicle body may be of a unibody construction in which a vehicle frame and the vehicle body are a unit (including frame rails, pillars, roof rails, etc.). As another example, the vehicle body and a vehicle frame may have a body-on-frame construction (also referred to as a cab-on-frame construction) in which the vehicle bod and vehicle frame are separate components, i.e., are modular, and the vehicle body is supported on and affixed to the frame. Alternatively, the vehicle bod may have any suitable construction. The vehicle body may be of any suitable material, for example, steel, aluminum, and/or fiber-reinforced plastic, etc.

The vehicle body includes body panels. The body panels may include structural panels, e.g., rockers, pillars, roof rails, etc. The body panels may include exterior panels. The exterior panels may present a class-A surface, e.g., a finished surface exposed to view by a customer and free of unaesthetic blemishes and defects. The body panels include, e.g., a floor panel, a roof panel, doors, fenders, hood, decklid, etc. The vehicle body may define an occupant cabin 30 to house occupants of the vehicle 10.

The vehicle 10 includes a floor 12 and may include a roof. The roof may define the upper boundary of the occupant cabin 30 and may extend from the front end of the occupant cabin 30 to the rear end of the occupant cabin 30. The floor 12 is below from the roof. The floor 12 defines the lower boundary of the occupant cabin 30 and may extend from the front end of the occupant cabin 30 to the rear end of the occupant cabin 30. The floor 12 may include the floor 12 panel of the body and may include a covering, e.g., carpet. The seat 14 is supported by the floor 12, i.e., the weight of the seat 14 is borne by the floor 12. Specifically, the seat 14 is supported by the floor panel of the vehicle body.

The vehicle 10 includes one or more seats 14 in the occupant cabin 30. The vehicle 10 may include any suitable number of seats 14. The seats 14 may be arranged in the occupant cabin 30 in any suitable position, i.e., as front seats, rear seats, third-row seats, etc. The seats 14 may be of any suitable type, e.g., a bench seat, a bucket seat, etc.

The seat 14 defines a seat-forward direction FD extending along a seat-forward axis CF. The seat-forward direction FD extends forward relative to the seat 14. The seat bottom 18 extends from the seatback 16 in the seat-forward direction FD. The occupant of the seat 14 faces in the seat-forward direction FD when properly seated in the seat 14. The seat bottom 18 extends from the seatback 16 in the seat-forward direction FD. The seat 14 defines the cross-seat axis CS and a seat-upright axis SU. A cross-seat direction CD extends in parallel with the cross-seat axis CS. In the example shown in the Figures, the vehicle seat 14 is elongated along the cross-seat axis CS. The seat-forward axis CF, the cross-seat axis CS, and the seat-upright axis SU are perpendicular to each other. The seat-forward axis CF is parallel with the vehicle-longitudinal axis L when the seat 14 is forward facing, the cross-seat axis CS is parallel with the cross-vehicle axis when the seat 14 is forward facing, and the seat-upright axis SU extends through the vehicle floor 12 and the vehicle 10 roof when the seatback 16 is in an upright position.

In the example shown in the Figures, the seat 14 is a second-row bench seat. In such an example, the seat 14, being a bench seat, includes multiple occupant-seating areas 32 and seatbelt assemblies 46 so that multiple occupants may be seated on the bench seat 14 simultaneously. In the example shown in the Figures, the vehicle seat 14 defines three occupant-seating areas 32.

The seat bottom 18 and the seatback 16 each include a frame (including a seat-bottom frame 34 and a frame of the seat back 16) and may include upholstery 60 supported on the frame. The seat-bottom frame 34 and the frame of the seatback 16 may include tubes, beams, etc. The seatback frame may be of any suitable material such as plastic (e.g., carbon fiber reinforced plastic (CFRP), glass fiber-reinforced semi-finished thermoplastic composite (organosheet), etc.) and/or metal (e.g., steel, aluminum, etc.).

The upholstery 60 of the seat 14 may include a covering and padding. The covering may be cloth, leather, faux leather, or any other suitable material. The covering may be stitched in panels around the frame. The padding may be between the covering and the frame 34 and may be foam or any other suitable material.

In some examples, including the example shown in the Figures, the seat 14 includes a second seat bottom 20. In such an example, the seat bottom 18 may be referred to as the first seat bottom 18. In the example shown in the Figures, the seat bottom 18 is rotatable relative to the seatback 16 between the deployed position and the raised position independently of the second seat bottom 20. In some examples, the second seat bottom 20 may be fixed in a deployed position, and in other examples, the second seat bottom 20 may be rotatable relative to the seatback 16 between a deployed position and a raised position independently of the seat bottom 18. In the example shown in the Figures, the seat bottom 18 defines two occupant-seating areas 32 and the second seat bottom 20 defines one occupant-seating area 32, as described further below. In examples including the second seat bottom 20, the seat bottom 18 and the second seat bottom 20 have separate frames, i.e., the seat-bottom frame 34 and the frame of the second seat bottom 20 are separate to allow for independent rotation of the seat bottom 18 relative to the second seat bottom 20. In such examples, the seatback 16 extends across both the seat bottom 18 and the second seat bottom 20.

The seat bottom 18 has a proximal end 36 and a distal end 38. The proximal end 36 is proximal to the seatback 16 at the rotational axis R. In examples including the seat bottom 18 and the second seat bottom 20, the proximal and the distal end 38 extend across the seat bottom 18 and the second seat bottom 20. The distal end 38 distal to the seatback 16. The seat bottom 18 extends from the seatback 16 in the seat-forward direction FD from the seatback 16 to the distal end 38. The seat bottom 18 includes a midline M between the proximal end 36 and the distal end 38. The midline M extends along the cross-seat axis CS in generally in parallel with the proximal end 36 and the distal end 38, and the midline M is equidistant to the proximal end 36 and the distal end 38.

The seat bottom 18 has a first end 40 and a second end 42 spaced from the first end 40 along the cross-seat axis CS. The first end 40 and the second end 42 extend from the proximal end 36 to the distal end 38 of the seat bottom 18. The first end 40 of the seat bottom 18 is spaced from the second side of the seat bottom 18 along the cross-seat axis CS. In the example shown in the Figures, the first end 40 is adjacent a door of the vehicle 10 and the second side is inboard of that door along the cross-seat axis. In examples including the second seat bottom 20, as shown in the Figures, the second end 42 of the seat bottom 18 is adjacent the second seat bottom 20 when the seat bottom 18 and the second seat bottom 20 are in the deployed position.

The seat 14 define occupant-seating areas 32. The occupant-seating area 32 is the space occupied by an occupant properly seated on the seat 14. The occupant-seating area 32 is seat-forward of the seatback 16 and above the seat bottom 18, e.g., the seat bottom 18 and the second seat bottom 20. The occupant-seating area 32 is on a front side of the seatback 16. In the example shown in the Figures, the seat 14 includes three occupant-seating areas 32. Two occupant-seating areas 32 are defined by the seat bottom 18 and one occupant-seating area 32 is defined by the second seat bottom 20.

The seat 14 defines pelvis-seating areas 44. The seat 14 includes a pelvis-seating area 44 for each occupant-seating area 32. In the example, shown in the Figures, the seat 14 includes three pelvis-seating areas 44, with two pelvis-seating areas 44 defined by the seat bottom 18 and a pelvis-seating area 44 defined by the second seat bottom 20. The pelvis-seating area 44 is the portion of the seat bottom 18 occupied by the pelvis of an occupant properly seated on the seat 14. The pelvis-seating areas 44 of the seat bottom 18 are between the midline M and the proximal end 36 of the seat bottom 18.

The vehicle 10 includes a seatbelt assembly 46 for each occupant-seating area 32 of the seat 14. The seatbelt assembly 46 may be a three-point harness, meaning that the webbing 48 is attached at three points around the occupant when fastened: an anchor, a seatbelt retractor, and a latch/buckle. The seatbelt assembly 46 may, in other examples, include another arrangement of attachment points.

The webbing 48 may extend continuously from the seatbelt retractor to the anchor. For example, one end of the webbing 48 feeds into the seatbelt retractor, and the other end of the webbing 48 is fixed to the anchor. The anchor may, for example, be fixed to the seat 14. Alternatively, the anchor may be fixed to the vehicle bod.

The webbing 48 may be fabric, e.g., woven polyester. A clip slides freely along the webbing 48 and, when engaged with the buckle , divides the webbing 48 into a lap belt 50 and a shoulder belt 52.

The vehicle seat 14 and the vehicle floor 12 define a cargo area 26 therebetween when the seat bottom 18 is in the raised position. Since the seat bottom 18 is upright in the raised position, the cargo area 26 expands when the seat bottom 18 is rotated from the deployed position to the raised position. The cargo area 26 is designed, i.e., sized, shaped, and positioned, to receive cargo that an occupant wishes to store in the occupant cabin 30. The cargo area 26 extends upwardly from the floor 12 and from the seat 14 to a vehicle-forward seat 14, e.g., a front seat in the example shown in the Figures.

The seatbelt retractor may be moveable from an unlocked position to a locked position by conventional mechanisms known in the art. In the unlocked position, the webbing 48 may be extended from and retracted into the seatbelt retractor. In the locked position, the seatbelt retractor prevents extension of the webbing 48 to limit the forward movement of the occupant. The seatbelt retractor may be in the unlocked position by default, i.e., in the absence of a sudden deceleration. The seatbelt retractor may change from the unlocked position to the locked position during a sudden deceleration of the vehicle 10, i.e., deceleration triggers components of the seatbelt retractor to change from the unlocked position to the locked position.

The seat bottom 18 is rotatably connected to seatback 16 about the rotational axis R. The seat bottom 18 may be directly connected to the seatback 16, e.g., through a hinge 54 on the seat bottom 18 and the seatback 16, or may be indirectly connected to the seatback 16, e.g., by direct connection between the seat bottom 18 and a base 56 of the seat 14, as described further below. The rotational axis R may extend along the cross-seat axis CS, e.g., may be parallel to the cross-seat axis CS. As set forth above, the seat bottom 18 is rotatable relative to the seatback 16 about the rotational axis R between the deployed position and the raised position. In the deployed position, the seat bottom 18 is positioned to support an occupant. For example, the seat bottom 18 is generally horizontal when the seat bottom 18 is in the deployed position. In the raised position, the seat bottom 18 is upright. For example, in the raised position, the seat bottom 18 is elongated in a plane that is generally vertical and may be generally parallel to a plane in which the seatback 16 is elongated.

The seat 14 may include one or more rotatable hinges 54 between the seat bottom 18 and the seatback 16. The rotatable hinge 54 may be of any suitable type, including, in some examples, those conventionally known to hinge a rotatable seat bottom 18 to a seatback 16. The seat 14 may include a lock to lock the seat bottom 18 in the raised position and/or the deployed position.

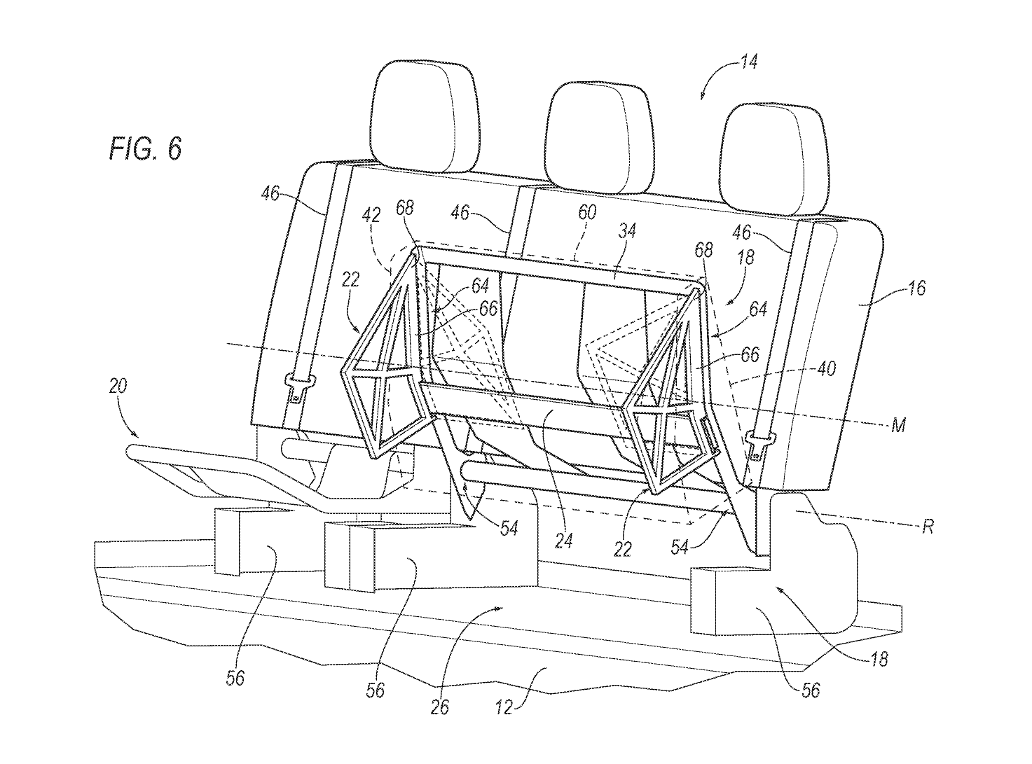

In the example shown in FIGS. 6-7, the legs 22 each include a top end 64 that rotates relative to the seat-bottom frame 34 as the legs 22 rotate between the extended position and the retracted position. Specifically, the legs 22 have a top member 66 connected to the hinge 54. At least a portion of the top member 66 abuts the seat-bottom frame 34 in the extended position and is spaced from the seat-bottom frame 34 in the retracted position. For example, as shown in the example in FIGS. 6-7, the top member 66 includes a seat-forward end 68 that abuts the seat-bottom frame 34 in the extended position and is spaced from the seat-bottom frame 34 in the retracted position. In the extended position, the abutment of the seat-forward end 68 against the seat-bottom frame 34 establishes at least a portion of a load path from the seat-bottom frame 34 to the floor 12 through the legs 22.

The vehicle seat 14 is mounted to the vehicle floor 12. As an example, the vehicle seat 14 includes one or more bases 56 that supports the seat bottom 18 and the seatback 16 on the floor 12, i.e., the weight of the seat bottom 18 and the seatback 16 is borne by base 56. The seatback 16 may be fixed to and stationary relative to the base 56. The seat bottom 18 may be fixed to the base 56 and/or the seatback 16, e.g., with the hinge 54. In the example shown in the Figures, the seatback 16 is fixed directly to the base 56, and the seat bottom 18 is rotatably fixed to the base 56 with the hinge 54.

The seat 14 includes two legs 22 fixed to the seat bottom 18. In other words, the legs 22 remain connected, directly or indirectly, to the seat bottom 18 and move with the seat bottom 18 between the deployed position and the raised position. The legs 22 contact the floor 12 in the deployed position and are spaced from the floor 12 in the raised position. The legs 22 may contact, for example, carpet of the floor 12 and/or an anchor point of the floor 12 designed to receive the legs 22. The seat 14 may include additional legs 22 between the second seat bottom 20 and the floor 12. The additional legs 22 may be identical to or different than the legs 22.

The legs 22 are spaced from each other along the cross-seat axis CS. One of the legs 22 is at the first end 40 of the seat bottom 18 and the other of the legs 22 is at the second end 42 of the seat bottom 18.

Each leg 22 may be a truss. In such examples, the truss includes an assemblage of members connected at nodes forming a rigid framework. The members may be elongated, i.e., having a thin width relative to length. The members may be unitary with each other at the nodes or may be formed separately and subsequently connected at the nodes, e.g., by welding, fasteners, brackets, etc. In examples in which the members are unitary, the truss is a single, uniform piece of material with no seams, joints, fasteners, or adhesives holding the members together at the nodes, i.e., formed together simultaneously as a single continuous unit, e.g., by machining from a unitary blank, molding, forging, casting, etc.

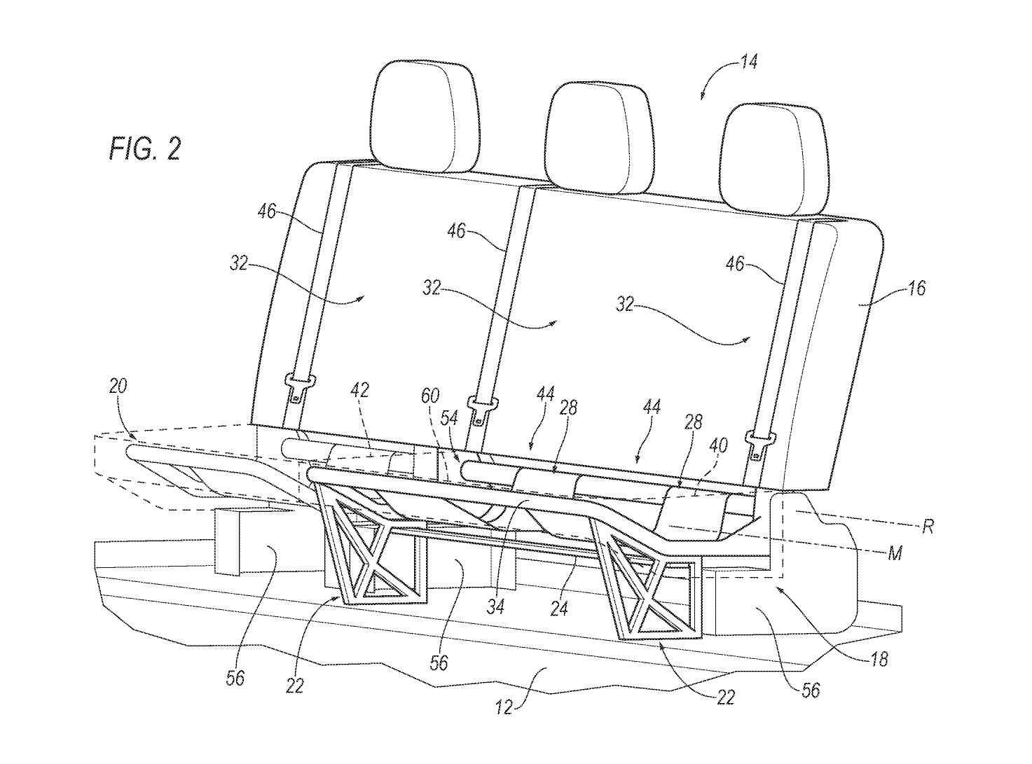

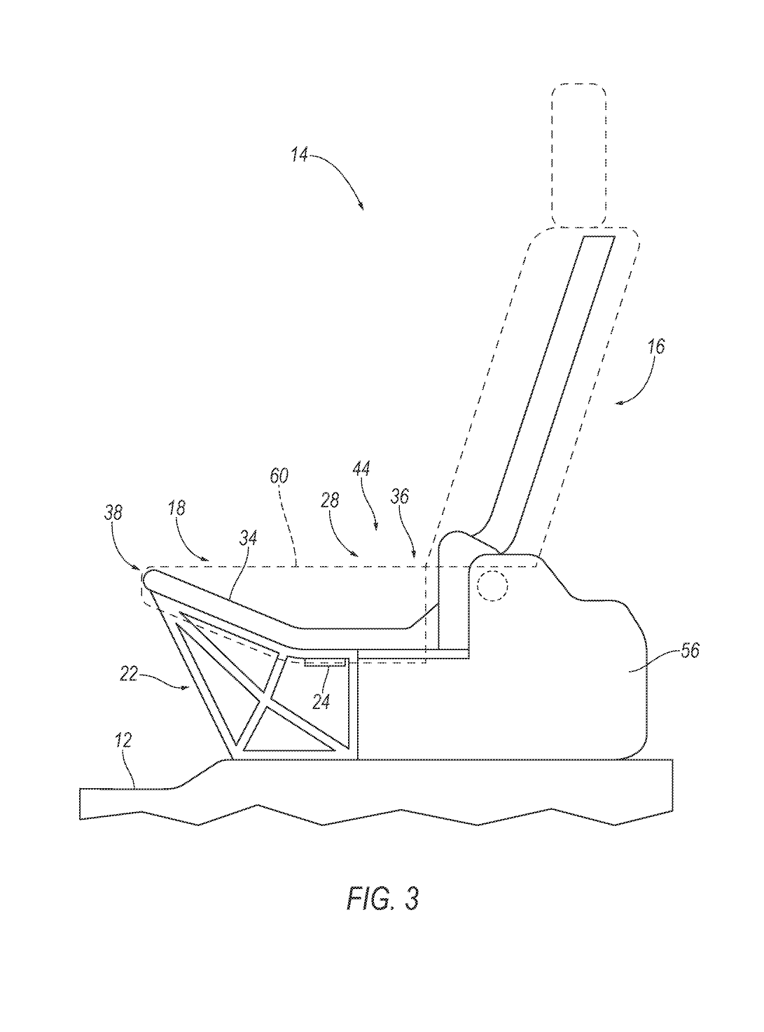

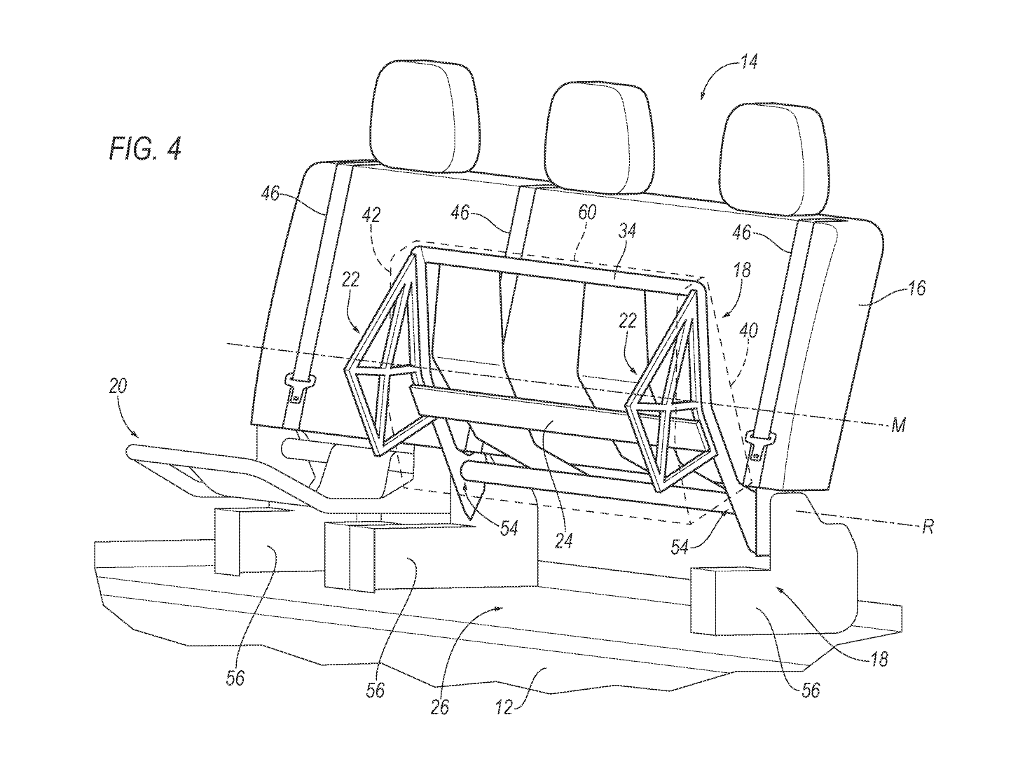

In some examples, such as the example shown in FIGS. 1-5, at least one of the legs 22 includes a hinge 58 mounted to the beam 24. In the example shown in the Figures, one leg 22 includes a hinge 58 between connected to the beam 24 and the other leg 22 includes a hinge 58 connected to the beam 24. The legs 22 are rotatable relative to the beam 24 at the hinges 58, respectively, between an extended position (FIG. 6) and a retracted position (FIG. 7). In the extended position, the leg 22 extends away from the seat bottom 18, e.g., in a plane transverse to the seat bottom 18, and in some examples, perpendicular to the seat bottom 18. When the seat bottom 18 is in the deployed position, the leg 22 in the extended position extends from the seat bottom 18 to the floor 12. In the retracted position, the leg 22 extends along the seat bottom 18, e.g., in a plane parallel to or generally parallel to the seat bottom 18. When the seat bottom 18 is in the raised position, the leg 22 in the retracted position is retracted relative to the cargo area 26 to expand the size of the cargo area 26. The hinge 58 may be of any suitable type, e.g., a butt hinge, a piano hinge, a concealed hinge, etc., in some examples, are of the type that are generally known.

The beam 24 extends along the cross-seat axis CS from one leg 22 to the other leg 22. The beam 24 is elongated along the cross-seat axis CS. In other words, the longest dimension of the beam 24 is along the cross-seat axis CS. In some examples, including the example shown in the Figures, the beam 24 may be elongated parallel to the cross-seat axis CS.

The beam 24 is fixed, directly or indirectly, to the seat bottom 18 and moves with the seat bottom 18 between the deployed position and the raised position. In the example shown in the Figures, the beam 24 abuts the seat bottom 18 and is fixed directly to the seat bottom 18. In the example shown in the Figures, the beam 24 is fixed directly to seat-bottom frame 34. In some examples, the beam 24 and the seat-bottom frame 34 are formed separately and subsequently assembled, e.g., by welding, threaded engagement, brackets, etc. In other examples, the beam 24 and the seat-bottom frame 34 may be unitary, e.g. formed together simultaneously as a single continuous unit by machining from a unitary blank, molding, forging, casting, etc.

The beam 24 is between the seat-bottom frame 34 and the legs 22. The beam 24 is fixed directly to the two legs 22 in the example shown in the Figures. In other words, no intermediate components are between the leg 22 and the seat-bottom frame 34. In the example shown in FIGS. 1-5, top ends of the legs 22 are fixed directly to the beam 24, e.g., by welding, threaded fasteners, brackets, etc. In the example, shown in FIGS. 6-7, the hinges 58 are fixed directly to the beam 24.

The vehicle seat 14 includes a load path from the beam 24 to the floor 12 through the legs 22. During certain vehicle impacts that result in the pelvis of the occupant being forced in a downward direction in compression against the pelvis area 28 of the seat bottom 18, the beam 24 distributes the downward force to the legs 22, and the seat 14 defines a load path from the beam 24 through the legs 22 to the floor 12. Accordingly, the beam 24 counteracts this downward force to control the kinematics of the occupant, including controlling the kinematics of the occupant relative to a lap belt 50 of the webbing 48 of the seatbelt assembly 46.

The beam 24 is between the midline M and the proximal end 36 of the seat bottom 18 Specifically, the beam 24 is directly below the pelvis-seating area 44 of the seat 14. Specifically, a vertical line through the beam 24 extends through the pelvis-seating area 44 of the seat 14 when the seat bottom 18 is in the deployed position.

The beam 24 is rigid relative to the upholstery 60 of the seat bottom 18. In other words, a downward force on the seat bottom 18 can deforms the upholstery 60 without deforming the beam 24. When the upholstery 60 is deformed when downward force is applied to the seat bottom 18, the beam 24 provides the load path to the legs 22.

Since the beam 24 extends from one leg 22 to the other leg 22, the beam 24 extends across two occupant-seating areas 32 of the seat 14. The beam 24 is designed (i.e., sized, shaped, oriented, of a material selection, etc.) to be rigid during downward force on the beam 24 during application of force associated with certain vehicle impacts that result in the pelvis of the occupant being forced in a downward direction in compression against the pelvis area 28 of the seat bottom 18.

The beam 24 is continuous, i.e., uninterrupted, from one leg 22 to the other leg 22 and from one end of the seat bottom 18 to the other end of the seat bottom 18. The beam 24 may be unitary from one leg 22 to the other leg 22, i.e., a single, uniform piece of material with no seams or joints on the beam 24 in between the legs 22.

The beam 24 may be, for example, metal. The is elongated along the cross-seat axis CS. In other words, the longest dimension of the beam 24 is along the cross-seat axis CS. The second largest dimension of the beam 24 may be along the seat-forward axis CF. In such an example, the thinnest dimension of the beam 24 is in a generally vertical direction.

The disclosure has been described in an illustrative manner, and it is to be understood that the terminology which has been used is intended to be in the nature of words of description rather than of limitation. The numerical adjectives “first” and “second” are used herein as identifiers and do not indicate order or importance. Many modifications and variations of the present disclosure are possible in light of the above teachings, and the disclosure may be practiced otherwise than as specifically described.

What is claimed is:

1. A vehicle comprising:
a vehicle floor; and
a vehicle seat mounted to the vehicle floor, the vehicle seat having a cross-seat axis;
the vehicle seat including a seatback;
the vehicle seat including a seat bottom rotatably connected to seatback about a rotational axis, the rotational axis extending along the cross-seat axis;
the seat bottom being rotatable relative to the seatback about the rotational axis between a deployed position and a raised position;
the seat including two legs fixed to the seat bottom and being spaced from each other along the cross-seat axis;
the legs being moveable with the seat bottom between the deployed position and the raised position, the legs contacting the floor in the deployed position and being spaced from the floor in the raised position; and
the vehicle seat including a beam fixed directly to the legs and extending along the cross-seat axis from one leg to the other leg, the beam moving with the seat bottom between the deployed position and the raised position.

2. The vehicle as set forth in claim 1, wherein the seat bottom has a proximal end proximal to the seatback at the rotational axis, a distal end distal to the seatback, and a midline between the proximal end and the distal end, the beam being between the midline and the proximal end.

3. The vehicle as set forth in claim 1, wherein the vehicle seat and the vehicle floor define a cargo area therebetween when the seat bottom is in the raised position.

4. The vehicle as set forth in claim 1, wherein the vehicle seat is elongated along the cross-seat axis.

5. The vehicle as set forth in claim 4, wherein the vehicle seat defines two occupant-seating areas.

6. The vehicle as set forth in claim 4, wherein the seat bottom has a first end and a second end spaced from the first end along the cross-seat axis, one of the legs being at the first end and the other of the legs being at the second end.

7. The vehicle as set forth in claim 1, wherein the seat bottom includes upholstery, the beam being rigid relative to the upholstery.

8. The vehicle as set forth in claim 1, wherein the vehicle seat includes a load path from the beam to the floor through the legs.

9. The vehicle as set forth in claim 1, wherein the seat bottom defines a pelvis-seating area and the beam is directly below the pelvis-seating area.

10. The vehicle as set forth in claim 1, wherein the seat bottom includes a seat-bottom frame, the beam being between the seat-bottom frame and the legs.

11. The vehicle as set forth in claim 10, further comprising a hinge mounted to each leg and to the beam, the legs being rotatable relative to the beam about the hinges, respectively, between an extended position and a retracted position.

12. The vehicle as set forth in claim 1, further comprising a hinge between each leg and the seat bottom, the legs being rotatable relative to the seat bottom about the hinges, respectively, between an extended position and a retracted position.

13. The vehicle as set forth in claim 1, wherein each leg is a truss.

14. A vehicle comprising:
a vehicle floor; and
a vehicle seat mounted to the vehicle floor, the vehicle seat having a cross-seat axis, the vehicle seat being elongated along the cross-seat axis and defining two occupant-seating areas;
the vehicle seat including a seatback;
the vehicle seat including a seat bottom rotatably connected to seatback about a rotational axis, the rotational axis extending along the cross-seat axis;
the seat bottom being rotatable relative to the seatback about the rotational axis between a deployed position and a raised position;
the seat bottom having a first end and a second end spaced from the first end along the cross-seat axis;
the seat bottom having a proximal end proximal to the seatback at the rotational axis, a distal end distal to the seatback, and a midline between the proximal end and the distal end;
the seat bottom defines a pelvis-seating area;
the seat including two legs fixed to the seat bottom, one of the legs being at the first end and the other of the legs being at the second end;
the two legs being moveable with the seat bottom between the deployed position and the raised position, the legs contacting the floor in the deployed position and being spaced from the floor in the raised position; and
the vehicle seat including a beam fixed directly to the two legs and extending along the cross-seat axis from one leg to the other leg, the beam moving with the seat bottom between the deployed position and the raised position.
the beam being between the midline and the proximal end directly below the pelvis-seating area;
the vehicle seat including a load path from the beam to the floor through the legs.

15. The vehicle as set forth in claim 14, further comprising a hinge between each leg and the seat bottom, the legs being rotatable relative to the seat bottom about the hinges, respectively, between an extended position and a retracted position.

16. The vehicle as set forth in claim 14, wherein each leg is a truss.

17. The vehicle as set forth in claim 14, wherein the seat bottom includes upholstery, the beam being rigid relative to the upholstery.
